(19) United States
(12) Patent Application Publication
(10) Pub. No.: US 2023/0092165 A1
(43) Pub. Date: Mar. 23, 2023

(54) METHOD FOR PRODUCING AN ELECTRODE POWDER MIXTURE FOR A BATTERY CELL

(71) Applicant: VOLKSWAGEN AKTIENGESELLSCHAFT, Wolfsburg (DE)

(72) Inventors: Christoph BOLLI, Braunschweig (DE); Tim Dagger, Lingen (DE); Chenjuan Liu, Braunschweig (DE); Paul Meister, IIsede (DE); Xin Qi, Munster (DE)

(73) Assignee: VOLKSWAGEN AKTIENGESELLSCHAFT, Wolfsburg (DE)

(21) Appl. No.: 17/950,531

(22) Filed: Sep. 22, 2022

(30) Foreign Application Priority Data
Sep. 23, 2021 (DE) 10 2021 210 652.8

(51) Int. Cl. H01M 4/36; H01M 4/04; H01M 4/139; H01M 4/62

(52) U.S. Cl. CPC H01M 4/366; H01M 4/0404; H01M 4/0435; H01M 4/0471; H01M 4/043; H01M 4/139; H01M 4/0419; H01M 4/622; H01M 4/624; H01M 2220/20

(57) ABSTRACT

The invention relates to a method for producing an electrode powder mixture for a battery cell. A powdered active material is provided with a powdered first polymer binder by means of electrostatic coating. The invention also relates to a method for producing an electrode of a battery cell.

### CROSS REFERENCE TO RELATED APPLICATION

This application claims priority from German Patent Application No. 10 2021 210 652.8, filed Sep. 23, 2021, which is hereby incorporated by reference in its entirety.

### FIELD OF THE INVENTION

The invention relates to a method for producing an electrode powder mixture for a battery cell, which is also referred to as an electrode blend. The invention also relates to a method for producing an electrode of a battery cell. The battery cell is preferably part of a motor vehicle.

### BACKGROUND OF THE INVENTION

Motor vehicles are increasingly being driven at least partially by means of an electric motor, so that they are designed as electric vehicles or hybrid vehicles. A high-voltage battery, which comprises a number of individual battery modules, is usually used to power the electric motor. The battery modules are usually structurally identical to one another and are electrically connected to one another in series and/or in parallel, so that the electrical voltage applied to the high-voltage battery corresponds to a multiple of the electrical voltage provided by each of the battery modules. Each battery module in turn comprises a plurality of batteries which are usually arranged in a common housing and which are electrically connected to one another in series and/or in parallel.

Each battery includes one or more battery cells, also known as galvanic cells. Each battery cell has two electrodes, namely an anode and a cathode, as well as a separator arranged between them and an electrolyte with freely mobile charge carriers. A liquid, for example, is used as such an electrolyte. In an alternative, the battery cell is configured as a solid-state battery, and the electrolyte is present in the form of a solid body.

The anode and cathode, which form the electrodes of the battery cell, typically include a conduc-tor/carrier which acts as a current collector. An active material, which is part of a layer applied to the carrier, is usually attached to this conductor/carrier. It is possible that the electrolyte is already present in the layer, or that it is introduced later. However, the active material is at least suitable for absorbing the working ions, e.g. lithium ions. Depending on whether it is used as an anode or cathode, a different material is used for the carrier and a different type of material is used for the layer.

In an alternative, the layer is applied as a paste or liquids to the carrier in question, also referred to as a conductor, and is then dried there. In this process, a solvent present in the liquid is con-verted or partially evaporated, creating a solid body. On the one hand, a comparatively large amount of energy is required to dry the liquid/paste, i.e. to release the solvent. On the other hand, it is necessary to dispose of the solvent thus released. Alternatively, the solvent is recovered so that it can be used in a new production process. However, this is comparatively time-consuming and energy-intensive.

An alternative to this is a so-called dry coating, which does not require the use of a solvent. In this case, however, it is necessary for the mixture of active material and binder, which is present as a powder, to have suitable properties so that a solid body is formed from the continuous layer after it has been applied to the conductor. A comparatively high force is usually applied for this purpose, however, damage to the individual particles of the active material or detachment of parts from the particles is possible. It is also possible that the homogeneity of the electrode powder mixture decreases during application, and the concentration of the binder is increased in certain areas and reduced in other areas. Consequently, the individual components do not adhere everywhere, which is why there is an increase in rejects. Also, the performance of the electrode is reduced due to the changed concentration.

### SUMMARY OF THE INVENTION

It is the object of the invention to provide a particularly suitable method for producing an electrode powder mixture for a battery cell and a particularly suitable method for producing an electrode for a battery cell, in which production costs are advantageously reduced and/or performance is increased.

With regard to the method for producing an electrode powder mixture, this object is achieved by the features claimed and with regard to the method for producing an electrode by the features claimed. Advantageous further developments and embodiments are the subject matter of the respective dependent claims.

The method is used to produce an electrode powder mixture for a battery cell. The battery cell is a galvanic element which has two electrodes, namely an anode and a cathode. A separator is expediently arranged between these elements, and the battery cell preferably comprises an electrolyte which provides a number of freely mobile charge carriers, such as lithium ions. For example, the electrolyte is a component of the anode and/or cathode, or is at least suitable for being attached there and thus being accommodated by them. The battery cell is a solid-state battery, for example, so that the electrolyte is present as a solid body. Alternatively, the electrolyte is liquid.

Each of the electrodes comprises a conductor, which is also referred to as a carrier. In particular, a layer is applied to each of the conductors, with at least one of the layers being created from the electrode powder mixture. The electrode powder mixture is adapted to the electrode in question, i.e. to the anode or cathode, so that it is either an anode powder mixture or a cathode powder mixture.

In the intended state, the battery cell is preferably a component of a motor vehicle. The battery cell is suitable, in particular provided and configured for this purpose. In the intended state, the battery cell is, for example, a component of an energy store of the motor vehicle, which has a plurality of such battery cells. The battery cells are preferably divided among a number of battery modules, which in turn are structurally identical to one another. Several battery cells are expediently combined into one battery and arranged in a common battery housing, wherein the batteries are electrically connected in series and/or in parallel to provide the particular battery module. The batteries are preferably structurally identical to one another and in particular are arranged in a housing of the energy store or of the respective battery module and are electrically connected to one another in parallel and/or in series. The electrical voltage applied to the energy store/battery module is therefore a multiple of the electrical voltage provided by means of each of the batteries. All battery cells are expediently structurally identical to one another, which simplifies manufacture.

The housing of the energy store/battery module is preferably made of a metal, for example steel, such as stainless steel, or an aluminum alloy. A die-casting process, for example, is used to produce the particular housing. In particular, the housing is designed to be closed. An interface which forms a terminal for the energy store/battery module is expediently introduced into the housing. The interface is electrically contacted with the batteries, so that electrical power can be fed into the batteries and/or electrical power can be drawn from the batteries from outside the energy store, provided that a corresponding connector is plugged into the terminal.

The motor vehicle is preferably land-based and preferably has a number of wheels, of which at least one, preferably a plurality thereof, or all of them, is/are driven by means of a drive. One of, preferably a plurality of, the wheels is suitably designed to be controllable. It is thus possible to move the motor vehicle independently of a specific roadway, for example rails or the like. Expediently, it is possible to position the motor vehicle essentially anywhere on a roadway that is made in particular from asphalt, tar or concrete. The motor vehicle is, for example, a commercial vehicle, such as a truck or a bus. However, it is particularly preferred that the motor vehicle is a passenger car.

The motor vehicle is expediently moved by means of the drive. For example, the drive, in particular the main drive, is designed to be at least partially electrical, and the motor vehicle is, for example, an electric vehicle. The electric motor is operated, for example, by means of the energy store, which is suitably designed as a high-voltage battery. An electrical DC voltage is expediently provided by means of the high-voltage battery, the electrical voltage being, for example, between 200 V and 800 V and, for example, essentially 400 V. An electrical converter, by means of which the power supply to the electric motor is set, is preferably arranged between the energy store and the electric motor. In one alternative, the drive also has an internal combustion engine, so that the motor vehicle is designed as a hybrid motor vehicle. In an alternative, a low-voltage electrical system of the motor vehicle is supplied with energy by means of the energy store, and, in particular, an electrical DC voltage of 12 V, 24 V or 48 V is provided by means of the energy store.

In an alternative, the battery cell is part of an industrial truck, an industrial plant or a hand-held device, such as a tool, in particular a cordless screwdriver. In a further alternative, the battery cell is part of an energy supply and is used there, for example, as a so-called buffer battery. In a further alternative, the battery cell is part of a portable device, for example a portable mobile phone, or some other wearable. It is also possible to use such a battery cell in the camping sector, in the model building sector or for other outdoor activities. In a further alternative, the battery cell is part of a charging station, for example a charging column, a drone or other aircraft, an e-scooter, an e-bike or a portable computer such as a laptop.

The method for producing the electrode powder mixture, which is also referred to as a blend or electrode blend, provides a powdered active material. A metal oxide is used as the active material, for example, preferably LiwNixCoyMnzO2 (w=0.8−1.4; x+y+z=1), an olivine, such as LiFePO₄, or a spinel, such as LiNi0.5Mn1.5O4, in particular if the electrode powder mixture is used for producing a cathode. In an alternative, a graphite, carbon, a silicon-containing material or a mixture thereof is used as the active material. The active material is powdered in each case and is therefore present in particular as a ground solid body. In particular, the grain size of the active material is smaller than 100 μm and, for example, larger than 100 nm. Consequently, the active material is formed from individual particles. For example, to provide the powdered active material, a solid body is ground.

In a further step, the powdered active material is provided with a powdered first polymer binder by means of electrostatic coating. In other words, a so-called “electrostatic coating” is used to provide the individual particles of the powdered active material with at least one particle of the powdered first polymer binder. Consequently, one of the particles of the first polymer binder then adheres to at least one particle of the powdered active material. In particular, a plurality of particles of the first polymer binder adhere to one particle of the active material.

Electrostatic coating is used for coating. In this process, the individual particles of the first polymer binder are provided with a specific electrical charge, for example. In particular, the first polymer binder, i.e. in particular its particles, is sprayed onto the active material. The active material is suitably located within a drum, which is expediently grounded or at least connected to ground. During the spraying, the drum is expediently rotated so that the active material is mixed substan-tially continuously. Consequently, all particles of the active material are each provided with at least one particle of the first polymer binder.

In the case of electrostatic coating, due to the different electrical charge one of the particles of the first polymer binder is initially attracted by one of the particles of the active material so that the latter adheres to it. Due to the electrical charge of this particle of the first polymer binder, further particles of the first polymer binder are at least partially held back from this particle of the active material, and thus are initially attached primarily to the particles of the active material that are not yet provided with one of the particles of the first polymer binder. Only when one of the particles of the first polymer binder is assigned to essentially all particles of the active material is it possible or at least made easier, due to the electrostatic interactions, for a further particle of the first polymer binder to attach to one of the particles of the active material that is already provided with a particle of the first polymer binder. Thus, essentially the same number of particles of the first polymer binder is assigned to each of the particles of the active material, thus increasing the homogeneity of the electrode powder mixture.

Due to the increased homogeneity of the electrode powder mixture, the performance of the electrode produced with it, and thus of the battery cells, is improved. Also, no solvent is required in the electrode powder mixture due to the homogeneous distribution of the first polymer binder, which reduces production costs.

Expediently, the electrode powder mixture is dry and particularly preferably solvent-free, so that no solvent has to be removed to produce an electrode, in particular a layer of the electrode for which the electrode powder mixture is used. Thus, the effort involved is reduced. In addition, with this method it is not necessary to use comparatively environmentally hazardous substances, so that environmental compatibility is increased. In the method, there are also only comparatively low requirements for the first polymer binder and the active material, so that the most varied materials can be used, thus reducing production costs.

For example, each particle of the active material is completely encased by and thus covered with the first polymer binder. Alternatively, the particles of the active material are not completely covered with the powdered first polymer binder, but the quantity of the first polymer binder is expediently such that comparatively stable adhesion of the particles of the active material to one another takes place via the first polymer binder. As a result, the stability of the active material is increased and, in particular, the flow behavior of the electrode powder mixture is changed.

The powdered active material is particularly preferably provided with a powdered first conductive additive by means of electrostatic coating. Here too, due to the electrostatic coating, the first conductive additive is distributed evenly over the active material, so that the homogeneity of the electrode powder mixture is increased. For example, the powdered first conductive additive, i.e. in particular the individual particles of the powdered first conductive additive, is applied after the powdered active material has been provided with the powdered first polymer binder. Particularly preferably, however, the powdered active material is first provided with the powdered first conductive additive by means of electrostatic coating, and the powdered active material and thus also the first conductive additive are then provided with the first polymer binder. As a result, an electrical resistance between the first conductive additive and the active material, namely the respective particles, is reduced. In particular, providing the first conductive additive by means of electrostatic coating is expediently carried out using the same machine. In particular, into the same drum, the powdered active material is filled in first, which is then provided with the powdered first conductive additive and then with the powdered first polymer binder, in each case by means of electrostatic coating.

For example, after the electrostatic coating, the electrode powder mixture is essentially immedi-ately further processed to form the electrode or, for example, is stored. Particularly preferably, however, the first polymer binder is melted on after electrostatic coating. For this purpose, heat is supplied, for example, and for which purpose, the drum is heated, for example. Alternatively, the active material and thus also the first polymer binder are irradiated by means of light, such as ultraviolet light or infrared light, preferably by means of a laser. Due to the melting of the first polymer binder, there is an at least partially substance-to-substance bond and/or form-fitting connection between the first polymer binder and the active material, and, if applicable, the first conductive additive. Due to the thus more stable connection, a comparatively long storage time of the composite of the active material and the first polymer binder, and in particular the first conductive additive, is possible without segregation occurring. Consequently, it is possible to produce the electrode powder mixture in advance and, if required, to produce corresponding electrodes for the battery cell from it. During the melting, in particular a partial liquefaction of the first polymer binder takes place, with the latter, for example, not completely changing into the liquid state, but in particular only becoming viscous or pasty. This avoids detachment from the particles of the active material, since in some cases a substance-to-substance bond is created between them.

For example, only the mixture of the powdered active material, which is provided with the first polymer binder and possibly the first conductive additive, is used as the electrode powder mixture. However, the active material coated with the first polymer binder is particularly preferably mixed with a further binder. In this case, there is expediently no electrostatic coating, but merely me-chanical mixing, for example likewise in the drum. In this way, the amount of binder in the electrode powder mixture is increased, but the effort involved in producing the electrode powder mixture is reduced. In particular, the further binder is not melted here, and the first polymer binder is preferably melted, so that there are at least different types of binders or at least different pro-cessing states of the binder. In particular, the further binder is also powdered or, for example, in particle form. For example, the further binder is made of the same material as the first polymer binder. Due to the use of the same chemical material, adhesion of the further binder to the first polymer binder is improved and thus also a connection of the individual active particles (particles of the active material) to one another, so that a comparatively stable layer can be created using the electrode powder mixture. As an alternative to this, the further binder is made from a different (chemical) material, so that in particular certain specifications can be met, for example, a comparatively high temperature resistance.

In an alternative embodiment, a powdered second conductive additive is provided with a powdered second polymer binder by means of electrostatic coating. For this purpose, a drum is also used, for example, into which the powdered second conductive additive provided with the powdered second polymer binder is introduced. In particular, the machines, in particular the drums, are identical in construction to one another. After both the active material has been provided with the first polymer binder and the second conductive additive has been provided with the second polymer binder, the active material coated, i.e. provided, with the first polymer binder is mixed with the second conductive additive provided with the second polymer binder. Consequently, the electrode powder mixture then has the active material and the second conductive additive. Such a procedure makes it possible to produce coated active material and coated second conductive additive comparatively independently of one another, so that the effectiveness and the possible production quantity are increased.

For example, the first polymer binder is the same as the second polymer binder, so that the number of different materials is reduced. Alternatively, the second polymer binder and the first polymer binder are different from one another. In this way it is possible to optimize the adhesion of the polymer binder to the active material or to the second conductive additive, so that stability is increased.

For example, after mixing, the first polymer binder and the second polymer binder are melted, so that stability is increased. However, the melting takes place particularly preferably before the mixing, so that in particular clumping is avoided. In particular, for melting, heat is supplied or the mixture is irradiated with light, for example ultraviolet light or infrared light.

For example, the grain size of the powdered first polymer binder is larger than the grain size of the powdered active material. However, the grain size of the powdered first polymer binder is particularly preferably smaller than or equal to the grain size of the powdered active material. It is thus possible for a plurality of particles of the first polymer binder to attach themselves to individual particles of the active material for coating. In addition, even after the electrostatic coating, the distance between the particles of the active material is comparatively small. The grain size of the powdered first polymer binder is expediently between 10 nm and 100 μm.

In particular, a polyvinyl acetate (PVAC), a polymethyl methacrylate (PMMA) or a cellulose nitrate, is used as binder, i.e. as the first polymer binder, second polymer binder and/or further binder. In an alternative, the binder in question is a fluoropolymer, such as polytetrafluoroethylene (PTFE), polyvinylidene fluoride (PVDF), tetrafluoroethylene-hexafluoropropylene copolymer (FEP) or vinylidene fluoride-hexafluoropropylene copolymer. In a further alternative, the respective binder is a rubber, such as styrene butadiene rubber (SBR) or an acrylonitrile. For example, the respective binder is made from the pure chemical material mentioned in each case or from a mixture of some of the chemical materials mentioned. For example, the individual binders are different from one another or are chosen to be the same.

In particular, the proportion of all binders in the electrode powder mixture, i.e. the first polymer binder, the second polymer binder and, if applicable, the further binder, is between 0.1% and 5% of the mass of the electrode powder mixture. In this way, robustness is increased, but the performance of the battery cell is not restricted.

Graphite, conductive carbon black, carbon nanotubes, carbon nanofibers or carbon fibers are used as the respective conductive additive, i.e. the first conductive additive or the second conductive additive. As an alternative to this, a fullerene, i.e. spherical molecules made of plastics atoms, is used as the respective conductive additive. For example, the respective conductive additive is formed from only one of these components, or the conductive additive comprises a mixture of the materials mentioned. In particular, the particle size of the respective powdered conductive additive is between 10 nm and 100 nm. As a result, attachment to the respective other particles is simplified. In particular, to provide the respective conductive additive in powder form, a solid body is first reduced in size accordingly, in particular ground.

The method for producing an electrode of a battery cell provides that an electrode powder mixture is first produced. To produce the electrode powder mixture, at least one powdered active material is provided with a powdered first polymer binder by means of electrostatic coating. The electrode powder mixture is then applied to a conductor, preferably by means of a roller press, a calender or a roller mill. In a preferred alternative, the electrode powder mixture is applied to the conductor by means of electrostatic coating. This enables the electrode powder mixture to be evenly distributed on the conductor.

The conductor is made in particular from a metal and is, for example, a metal foil. Aluminum or copper is more expediently used as the metal. The conductor is in particular in the form of a sheet or strip. An adhesion promoter layer is preferably applied to the conductor before the electrode powder mixture is applied, so that adhesion of the electrode powder mixture is improved. The adhesion promoter layer is created, for example, from a carbon and one of the possible binders or a completely different binder.

A layer that is continuous, for example, is then preferably created from the electrode powder mixture. For this purpose, in particular the electrode powder mixture and/or the conductor is heated and, for example, pressure is exerted on the electrode powder mixture in the direction of the conductor. For this purpose, for example, the electrode powder mixture is irradiated with light or subjected to a heated press. Alternatively or in combination with this, the electrode powder mixture is calendered, for which purpose a calender is used in particular, for example a 4-roll calender, so that the conductor is provided with the layer on both sides. A thickness of the electrode powder mixture on the conductor and thus the thickness of the layer is adjusted by means of the calender, in particular in a calendering process. Here, the calendering takes place in particular after the heating and the pressing. In an alternative, this working step is also carried out by means of the calender, for which purpose in particular any rolls of the calender are heated.

To summarize, the layer which is applied to the conductor and which comprises the active material of the respective electrodes is expediently created from the electrode powder mixture. The material of the conductor and/or the active material is selected depending on the electrode, i.e. whether it is a cathode or an anode. Preferably, the electrode is produced without the use of a solvent, which would be removed from the electrode powder mixture to produce the layer. In other words, the method for producing the electrode is solvent-free.

The invention also relates to an electrode produced in this way and to a battery cell with two electrodes, with at least one of the two electrodes, preferably both, being produced in accordance with such a method.

The advantages and developments described in connection with the two methods can also be transferred to the use/electrode/battery cell and to one another and vice versa.

### BRIEF DESCRIPTION OF THE DRAWINGS

In the following, embodiments of the invention are described in more detail with reference to the drawings, in which:

FIG. 1 is a schematically simplified view of a motor vehicle having a high-voltage battery with a plurality of structurally identical battery cells,

FIG. 2 is a side view of one of the structurally identical battery cells,

FIG. 3 shows a method for producing an electrode for a battery cell, comprising a method for producing an electrode powder mixture,

FIG. 4 shows a machine for producing the electrode powder mixture,

FIGS. 5-8 show greatly simplified and enlarged views of the electrode powder mixture at different stages of production,

FIG. 9 shows a further machine for producing the electrode,

FIG. 10 shows an alternative embodiment of the method for producing the electrode powder mixture, and

FIGS. 11-17 show greatly simplified and enlarged views of the electrode powder mixture produced according to the alternative embodiment at different stages of production.

Correspond parts are provided with the same reference signs in all figures.

### DETAILED DESCRIPTION OF THE INVENTION

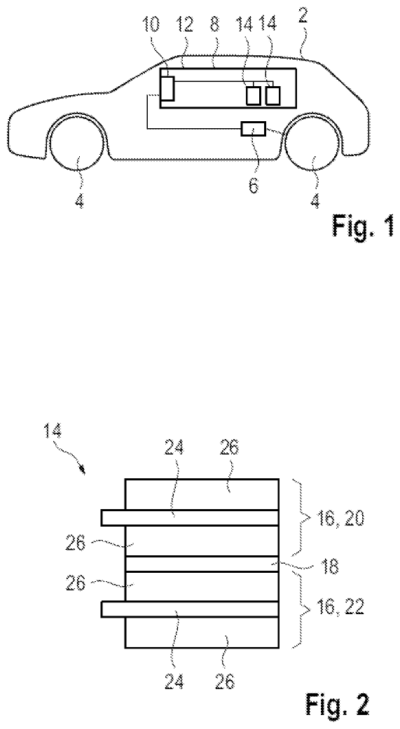

In FIG. 1, a motor vehicle 2 in the form of a passenger vehicle is shown in a schematically simplified manner. The motor vehicle 2 has a number of wheels 4, at least some of which are driven by means of a drive 6 which comprises an electric motor. Thus, the motor vehicle 2 is an electric vehicle or a hybrid vehicle. The drive 6 has a converter, by means of which the electric motor is powered. The converter of the drive 6 in turn is powered by an energy store 8 in the form of a high-voltage battery. For this purpose, the drive 6 is connected to an interface 10 of the energy store 8, which interface is introduced into a housing 12 of the energy store 8 which is made of stainless steel. A plurality of battery modules which are in electrical contact with one another are arranged inside the housing 12. Some of the battery modules are electrically connected to one another in series and these, in turn, are electrically connected to one another in parallel. The electrical assembly of the battery modules is in electrical contact with the interface 10 so that the battery modules are discharged or charged (recuperation) when the drive 6 is in operation. Because of the electrical interconnection, the electrical voltage provided at the interface 10, which is 400 V, is a multiple of the electrical voltage provided with the battery modules that are structurally identical to one another.

Each of the battery modules that are structurally identical to one another has a plurality of batteries that are structurally identical to one another and are electrically connected to one another in series and/or in parallel to form the specific battery module. Each of the batteries in turn has a plurality of battery cells 14 which are structurally identical to one another, two of which are shown here.

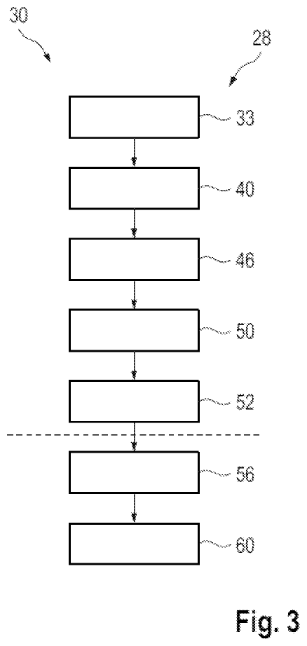

In FIG. 2, one of the structurally identical battery cells 14 is shown in a schematically simplified side view. The battery cell 14 has two electrodes 16 which are separated from one another by a separator 18. The two electrodes 16 and the separator 18 are stacked one on top of the other and are in direct contact with one another. One of the electrodes 16 is an anode 20 and the remaining of the electrodes 16 is a cathode 22.

The two electrodes 16 are constructed identically to one another and each have a conductor 24, which is also referred to as a carrier and is made of a metal foil. In the case of the anode 20, the conductor 24 is made of copper foil and in the case of the cathode 22 it is made of aluminum foil. A layer 26, the thickness of which is between 60 μm and 100 μm, is applied to both sides of each of the sheet-like conductors 24.

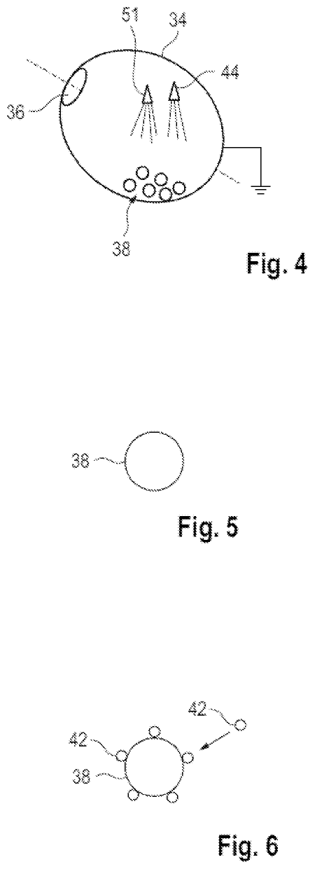

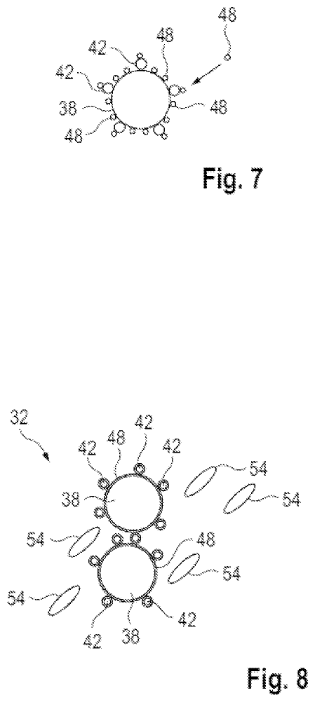

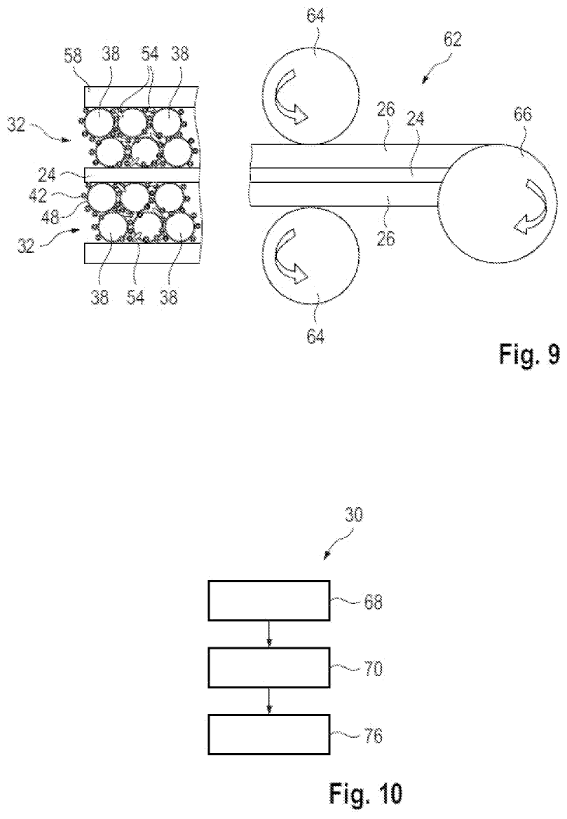

A method 28 for producing one of the electrodes 16 for the battery cell 14 is shown in FIG. 3. In the method 28 for producing the electrode 16, a method 30 for producing an electrode powder mixture 32 (FIG. 8) is first carried out. In a first working step 33, a powdered active material 38 is introduced through a filling opening 36 into a drum 34 shown in FIG. 4, a particle of the active material being shown in a schematically simplified view in FIG. 5. The powdered active material is tailored to the later use of the electrode 16 as anode 20 or cathode 22, and in this example it is graphite if the electrode is to form the anode 20. If the electrode 16 will form the cathode 22, the active material 38 LiFePO4 or NMC is used. The individual particles of the powdered active material 38 have a grain size of 1 μm, and to produce the powdered active material 38 a solid body is first ground in a method that is not shown in detail.

In a second working step 40, the (powdered) active material 38 is provided with a powdered first conductive additive 42 by means of electrostatic coating. For this purpose, a spray head 44 is arranged inside the drum 34, and by means of this the particles of the first conductive additive 42 are electrically charged and sprayed onto the particles of the powdered active material 38. The particles of the active material 38 are grounded via the metallic drum 34 so that the particles of the first conductive additive 42 are attracted to the particles 38 of the active material 38. During the electrostatic coating, the drum 34 is also rotated so that all particles of the powdered active material 38 are provided with at least one of the particles of the first conductive additive 42. Conductive carbon black is used as the first conductive additive 42, and as soon as one of the particles of the first conductive additive 42 has attached to one of the particles of the active material 38, the composite of these has a specific electrical charge, which prevents or at least makes more difficult/delays the attachment of further particles of the first conductive additive 42 until at least the same number of particles of the first conductive additive 42 have also attached to the majority of the remaining particles of the active material 38. Then there is no longer any difference between the charge of the composites produced in this way. Following this, attachment of a further particle of the first conductive additive 42 to the particles of the active material 38 is facilitated, so that the particles of the powdered active material 38 are coated essentially uniformly.

In a subsequent third working step 46, the powdered active material 38, the particles of which already have particles of the powdered first conductive additive 42 attached to them, is provided with a powdered first polymer binder 48 by means of the same spray head 44, namely also by means of electrostatic coating. In this process, the first polymer binder 48 also partially attaches itself to the particles of the first conductive additive 42 which are already adhering to one of the particles of the active material 38. The drum 34 is also rotated during the electrostatic coating. In a variant that is not shown in detail, a separate spray head is used to provide the powdered active material 38 with the powdered first polymer binder 48. The electrostatic coating also takes place by means of this separate spray head, and the separate spray head is also arranged inside the drum 34.

A fluoropolymer, namely polytetrafluoroethylene (PTFE) is used as the first polymer binder 48, and during spraying by means of the spray head 44, the drum 34 continues to rotate. The grain size of the powdered first polymer binder 48 is 200 nm and is therefore selected to be smaller than the grain size of the powdered active material 38. The grain size of the first conductive additive 42 is also selected to be between 100 nm and 500 nm and is therefore smaller than the grain size of the powdered active material 38.

In a subsequent fourth step 50, which is carried out when the electrostatic coating has ended, the first polymer binder 48 is melted. A light source 51 by means of which infrared light is emitted is arranged inside the drum 34 and is used for melting. In this process, as shown in FIG. 8, the individual particles of the first polymer binder 48, which are associated with the respective same particle of the active material 38 partially combine, so that the respective particle of the active material 38 is coated with the particles of the first conductive additive 42 adhering to it. In this way, the particles of the powdered active material 38 are also partially connected to one another by means of the first conductive additive 42. In one variant, the melting takes place by heating the drum 34, or the powdered contents of the drum 34 are emptied and moved through a continuous furnace.

In a subsequent fifth working step 52, the material produced in this way is mixed with a powdered further binder 54, which is also in particle form and whose particle size is between 500 nm and 800 nm. The further binder 54 is also, for example, polytetrafluoroethylene (PTFE) or, in an alternative embodiment, polymethyl methacrylate (PMMA), i.e. it is chemically different from the first polymer binder 48. The further binder 54 is merely poured into the drum 34 via the filling opening 36, with the drum 34 being rotated further so that mixing takes place. Subsequent to this, the method 30 for producing the electrode powder mixture 32 is ended. The fifth working step 52 is optional, and in a variant that is not shown in detail, the further binder 54 is not used.

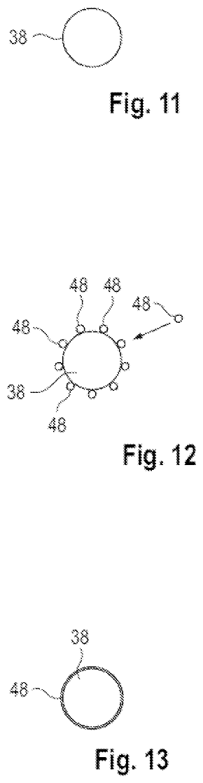

In a subsequent sixth working step 56, the electrode powder mixture 32 created in this way is applied to both sides 24 of the respective conductor by means of electrostatic coating, as shown in FIG. 9. The conductor 24, which is also referred to as a carrier, is in the form of a metal strip that is unwound from a roll that is not shown in detail. Because the first polymer binder 48 has already melted, the particles of the first conductive additive 42 are held on the particles of the active material 38, so that the homogeneity of the electrode powder mixture 32 is retained even during the coating.

After the conductor 24 has been coated with the electrode powder mixture 32, it is heated and fed through a press 58, which is designed as a so-called “hot press” or “heat press”. By means of this press, pressure is exerted on the layers 26 in the direction of the conductor 24, so that the density of the electrode powder mixture 32 is reduced. For this purpose, any free spaces between the particles of the active material 38 are reduced or removed. Furthermore, heat is emitted by means of the press 58, so that the further binder 54 and the first polymer binder 48 are melted, which is why they bond to one another and to the first conductive additive 42 and the particles of the active material 38, so that the respective cohesive layer 26 is formed. A subsequent relative movement of the individual particles of the electrode powder 32 is thus prevented.

In a subsequent seventh working step 60, the conductor 24, which is provided with the layer 26 on both sides, is moved through a calender 62 which comprises two rollers 64. The layers 26 are further compressed by means of the calender 62 and their porosity is further reduced. It is also ensured in this way that the layers 26 have a predetermined thickness. The conductor 24 provided with the layers 26 is then rolled up onto a roll 66. If necessary, this is unrolled and cut to length to produce the respective electrode 16. In a variant that is not shown in detail, the press 58 is not present, and after the electrode powder mixture 32 has been applied to the conductor 24 by means of electrostatic coating, the conductor 24 is moved directly through the calender 62, the rollers 64 of which are heated, so that by means of this the further binder 54 and the first polymer binder 48 are melted and connected.

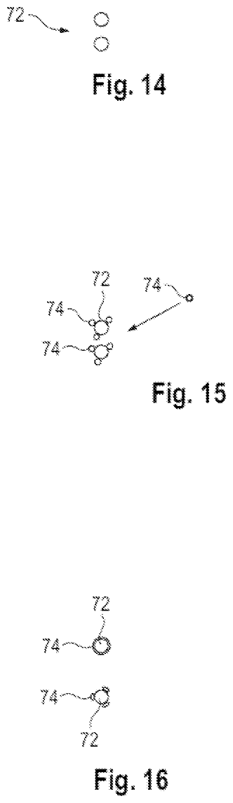

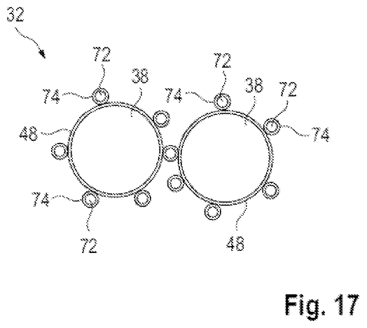

A variant of the method 30 for producing the electrode powder mixture 32 is shown in FIG. 10. This method begins with an eighth working step 68, in which first the powdered active material 38 is provided and introduced into the drum 34. Thus, in turn, there are a plurality of particles of the active material 38, one of which is shown in FIG. 11. Subsequently, the powdered active material 38, i.e. the individual particles of the active material 38, is provided with the powdered first polymer binder 48, namely individual particles thereof, by means of electrostatic coating, as shown in FIG. 12. The spray head 44 is used for spraying, and meanwhile the drum 34 is again rotated.

As soon as all particles of the active material 38 have been provided with sufficient particles of the first polymer binder 48, the first polymer binder 48 is melted so that the individual particles of the first polymer binder 48 adhering to one of the particles of the active material 38 fuse with one another and encase the particle 38, as shown schematically in FIG. 13. In other words, the eighth working step 68 corresponds to the first working step 33 and the third working step 46 and the fourth working step 50, whereby, however, the first conductive additive 42 is not present.

In a subsequent ninth working step 70, a powdered second conductive additive 72 is provided, of which two particles are shown in FIG. 14. This can again be conductive carbon black. The particles of the second conductive additive 72 are provided with a second polymer binder 74 by electrostatic coating. As a result, individual particles of the second polymer binder 74 attach themselves to the particles of the second conductive additive 72. For example, the same drum 34 from which the active material 38 was removed is used for electrostatic coating. However, it is also possible to use a machine of the same design, which also has a drum 34, or a machine of a different design. Subsequently, the second polymer binder 74 is also melted, so that the individual particles of the second conductive additive 72 are, for example, completely or at least partially connected to the second polymer binder 74, with a partially form-fitting connection and/or substance-to-substance bond being created between them. In summary, the eighth working step 68 corresponds to the ninth working step 70, but different materials are used. For example, the second conductive additive 72 is used instead of the active material 38 and the second polymer binder 74 is used instead of the first polymer binder 48. In one embodiment, the first polymer binder 48 and the second polymer binder 74 are chemically identical to one another. To summarize, the powdered second conductive additive 72 is thus provided with the powdered second polymer binder 74 by means of electrostatic coating.

In a subsequent tenth working step 76, the active material 38 provided, i.e. coated, with the first polymer binder 48 is mixed with the second conductive additive 72 provided with the second polymer binder 74, i.e. the specific coated powder, so that the electrode powder mixture 32 is formed, which is shown in FIG. 17. In this process, the first polymer binder 48 is connected with the second polymer binder 74, so that via this connection the particles of the active material 38 and of the second conductive additive 20 partially adhere to one another and consequently the electrode powder mixture 32 is homogeneous, and also remains so during storage.

The invention is not restricted to the embodiments described above. Rather, other variants of the invention can also be derived therefrom by a person skilled in the art without departing from the subject matter of the invention. In particular, all of the individual features described in connection with the individual embodiments can also be combined with one another in other ways without departing from the subject matter of the invention.

### LIST OF REFERENCE SIGNS

2 motor vehicle
4 wheel
6 drive
8 energy store
10 interface
12 housing
14 battery cell
16 electrode
18 separator
20 anode
22 cathode
24 conductor
26 layer
28 method for producing an electrode
30 method for producing an electrode powder mixture
32 electrode powder mixture
33 first working step
34 drum
36 filling opening
38 active material
40 second working step
42 first conductive additive
44 spray head
46 third working step
48 first polymer binder
50 fourth working step
51 light source
52 fifth working step
54 further binder
56 sixth working step
58 press
60 seventh working step
62 calender
64 roller
66 roll
68 eighth working step
70 ninth working step
72 second conductive additive
74 second polymer binder
76 tenth working step

1. A method for producing an electrode powder mixture of a battery cell, in which a powdered active material is provided with a powdered first polymer binder by means of electrostatic coating.

2. The method according to claim 1, wherein the powdered active material is provided with a powdered first conductive additive by means of electrostatic coating.

3. The method according to claim 2, wherein the first polymer binder is melted after the electrostatic coating.

4. The method according to claim 2, wherein the active material coated with the first polymer binder is mixed with a further binder.

5. The method according to claim 1, wherein a powdered second conductive additive is provided with a powdered second polymer binder by means of electrostatic coating and is then mixed with the active material coated with the first polymer binder.

6. The method according to claim 5, (38) the first polymer binder and the second polymer binder are melted before the mixing.

7. The method according to claim 1, (38) the grain size of the powdered first polymer binder is selected to be smaller than or equal to the grain size of the powdered active material.

8. A method for producing an electrode of a battery cell, in which an electrode powder mixture is produced according to a method for producing an electrode powder mixture for a battery cell according to claim 1 and the electrode powder mixture is applied to a conductor.

9. The method according to claim 8, (38) the electrode powder mixture applied to the conductor is heated and pressed and/or calendered.
